(19) United States
(12) Patent Application Publication
(10) Pub. No.: US 2004/0079614 A1
(43) Pub. Date: Apr. 29, 2004

(54) Currency and coupon acceptor with coupon printer

(76) Inventors: David R. Orton, West Yorkshire (GB); Michael S. Allen, Cleveland Heights, OH (US); Ronald W. Rollins, Perry, OH (US); Patrick Swetel, Eastlake, OH (US)

Correspondence Address: Ray L Weber, Renner Kenner Greive Bobak Taylor & Weber, Fourth Floor, First National Tower, Akron, OH, 44308-1456, US

(21) Appl. No.: 10/450,754

(22) PCT Filed: Oct. 16, 2002
(86) PCT No.: PCT/US02/32294

(51) Int. Cl. G07F 7/00

(52) U.S. Cl. 194/212

(57) ABSTRACT

A currency and coupon acceptor particularly adapted for the gaming industry is presented. A validator is provided within a housing and is adapted for determining the authenticity and associated value of paper currencies and coupons tendered thereto. A stacker is received within the housing for receiving and maintaining currencies and coupons determined to be valid. A tray of blank coupons is also provided in association with a printer that generates coupons for dispensing from the acceptor. The validator verifies that the printing of the coupons has been accurately undertaken and, if so, the coupons are dispensed by the acceptor and, if not, the coupons are voided by the printer and passed to the stacker. The invention contemplates various configurations in which the tray of blank coupons may be positioned beneath the validator, above the validator, or pivotally behind the stacker.

### TECHNICAL FIELD

The invention herein resides in the art of currency and coupon acceptors, as particularly adapted for implementation with gaming machines and the like. More specifically, the invention relates to a combination currency and coupon acceptor having a coupon printer in the same housing.

### BACKGROUND ART

It has become commonplace to employ currency validators or acceptors in association with gaming machines. It has similarly become commonplace to employ coupon acceptors and printers with gaming machines, the use of coupons eliminating the excessive handling of cash within the gaming establishment, thus reducing opportunities for theft and loss. While it has become commonplace to employ both currency validators or acceptors and coupon acceptors in gaming establishments, these devices have generally comprised separate devices or, to the extent that such acceptors might be combined in a single housing, that single housing has been of significant size. In gaming establishments and the like, space is at a premium and, accordingly, it is most desirable that coupon and currency validators be of reduced size and, if at all possible, be maintained in a single housing.

Presently, there is no known unit in which a currency and coupon acceptor are both housed in the same housing with a coupon printer, while occupying the space typically required for a currency validator.

### SUMMARY OF THE INVENTION

In light of the foregoing, it is a first aspect of the invention to provide a currency and coupon acceptor in association with a coupon printer, all embodied in a single housing.

Another aspect of the invention is the provision of a currency and coupon acceptor with a coupon printer in which the single housing maintaining such device is no larger than the housing typically employed for a currency validator.

Still a further aspect of the invention is the provision of a currency and coupon acceptor with a coupon printer, in which the acceptors for both currency and coupons employ the same transport and validation paths.

Another aspect of the invention is the provision of a currency and coupon acceptor with a coupon printer, wherein the same sensors are employed to verify both the coupons received and those printed and dispensed thereby.

Yet a further aspect of the invention is the provision of a currency and coupon acceptor with a coupon printer, in which invalidated coupons are not dispensed to the customer or user, but are instead “spoiled” or otherwise obliterated and placed within the associated stacker.

Still another aspect of the invention is the provision of a currency and coupon acceptor with a coupon printer, in which a single stacker is employed to receive both coupons and currency.

Yet another aspect of the invention is the provision of a currency and coupon acceptor with a coupon printer, in which a “smart” chip is employed in association with the coupon tray.

Still another aspect of the invention is the provision of a currency and coupon acceptor with a coupon printer, in which the currency acceptor and coupon acceptor are mutually exclusively operative.

Yet another aspect of the invention is the provision of a currency and coupon acceptor with a coupon printer, including a splitting device to facilitate the separation of single coupons from a web of fan folded coupons received and dispensed from a tray cassette.

Still another aspect of the invention is the provision of currency and coupon acceptor with coupon printer in which the coupon printer is a part of the coupon tray which may be slid as a unit from the mechanism housing.

The foregoing and other aspects of the invention which will become apparent as the detailed description proceeds are achieved by a currency and coupon acceptor, comprising: a housing; a validator received within said housing for determining the authenticity and associated value of paper items tendered thereto; a stacker received within said housing for receiving and maintaining tendered paper items determined to be authentic; a printer in association with said tray of blank coupons for printing data upon coupons dispensed from said tray; and a note path interconnecting said validator, tray of blank coupons, stacker and printer for transporting said paper items.

Other aspects of the invention which will become apparent as the detailed description proceeds are achieved by a currency and coupon acceptor with a coupon printer in which a single housing, no larger than a typical housing for a currency validator, receives both a currency acceptor and a coupon acceptor along with a coupon printer, and in which both acceptors employ the same transport and validation paths and the same stacker.

Other aspects of the invention are achieved by a currency and coupon acceptor with coupon printer as set forth above, and in which the printer is part and parcel of a tray for receiving unprinted coupons.

Other aspects of the invention are obtained by a currency and coupon acceptor with coupon printer as presented above, and in which a protrusion is presented within the transport path to facilitate separation of coupons one from the other.

### DESCRIPTION OF THE DRAWINGS

For an understanding of the objects, techniques and structure of the invention, reference should be made to the following detailed description and accompanying drawings wherein:

FIG. 1 is a perspective view of a currency and coupon acceptor with coupon printer made in accordance with the invention;

FIG. 2 is a cross sectional view of the structure of FIG. 1;

FIG. 3 is an operative illustration of the structure of FIG. 1, showing the coupon tray and printer assembly withdrawn from the housing;

FIG. 4 is a partial cross sectional view of the transport path, showing a protrusion to facilitate separation of coupons;

FIG. 5 is a perspective view of an embodiment of the invention showing the coupon tray and printer above the currency validator;

FIG. 6 is an illustration of the embodiment of FIG. 5 showing the coupon tray partially removed in a receiving track;

FIG. 7 is a cross sectional view of the embodiment of FIG. 5;

FIG. 8 is a perspective view of another embodiment of the invention, wherein the coupon printer and tray are pivotally maintained behind the stacker of the system;

FIG. 9 is an illustration of the embodiment of FIG. 8, showing the stacker removed and with the coupon tray and printer pivoted downwardly from its back position and with the tray extended;

FIG. 10 is a cross sectional view of the embodiment of FIG. 8, showing the coupon tray pivotally maintained at the bottom thereof and having a printer head at the top thereof in communication with the transport path;

FIG. 11 is a perspective view of still another embodiment of the invention, having the coupon tray and printer behind the stacker and employing a rotating chassis for the acceptor/printer assembly;

FIG. 12 is a perspective view of the embodiment of FIG. 11, showing the chassis rotated from its housing; and

FIG. 13 is a cross sectional view of the embodiment of FIG. 11, showing the coupon tray and printer in communication with the transport path.

### BEST MODE FOR CARRYING OUT THE INVENTION

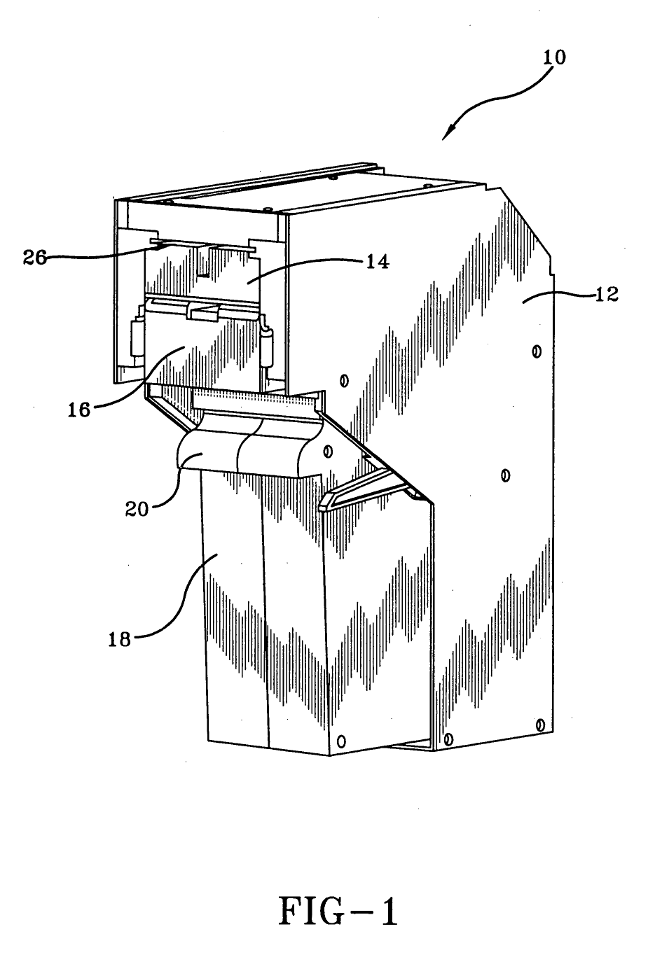

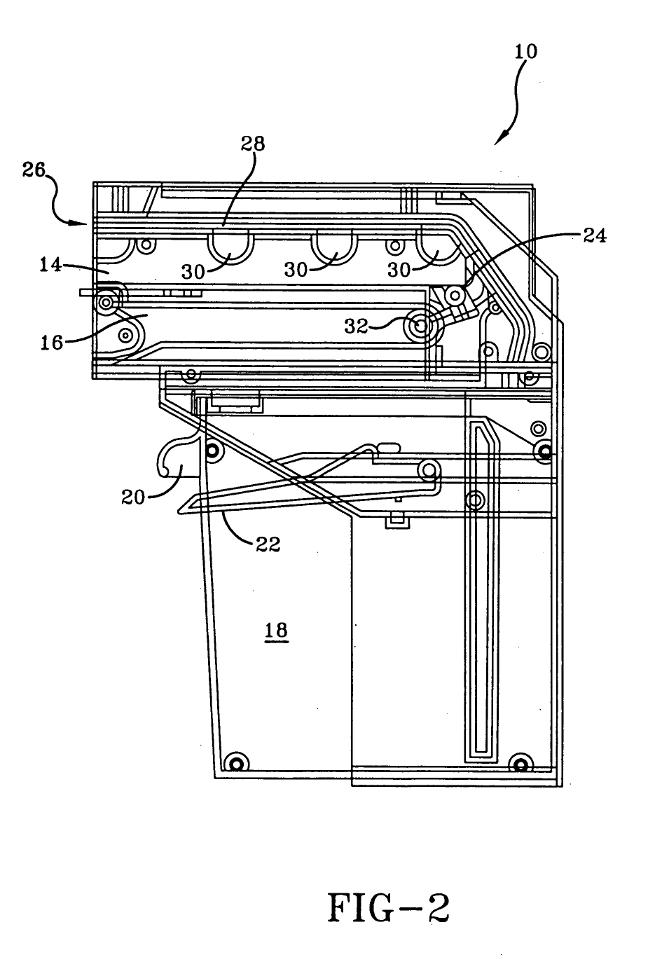

Referring now to the drawings and more particularly FIGS. 1-3, an appreciation of the concept of the invention can be readily attained. Therein, an acceptor and printer made in accordance with the invention is designated generally by the numeral 10. The acceptor and printer assembly 10 is capable of receiving and authenticating both currency and printed coupons, and is further capable of printing and dispensing such coupons. It will be understood that the acceptor and printer assembly 10 is contemplated for implementation with gaming machines and, in that regard, communicates with the gaming machine to authorize play, debit charges, and credit wins through the printing and dispensing of coupons.

In the context of the invention, it is contemplated that the coupon may include a coded cash value thereon, such as in the form of a bar code as is presently known. Alternatively, the coupons may receive standard alpha-numeric characters indicating the cash value of the coupon. The invention contemplates either, the bar code version being known from the prior art, and the alpha-numeric character version constituting a novel feature of the instant invention. Accordingly, the invention contemplates the employment of either or both bar code printers and readers or alpha-numeric printers and readers, the latter employing standard character recognition techniques.

The instant invention further contemplates that a combination currency acceptor and coupon acceptor/printer may be incorporated within the same housing and “footprint” previously provided for currency validators or acceptors alone. Accordingly, it is contemplated that the overall dimensions of the acceptor and printer assembly 10 will have a major height of less than 12 inches (30.5 cm), a major width of less than 4.6 inches (11.7 cm), and a major depth of less than 10.4 inches (26.4 cm). As a consequence, the acceptor and printer of the instant invention can be adapted for receipt in an assembly package presently receiving and maintaining only a currency validator or acceptor alone.

With continued reference to FIGS. 1-3, it can be seen that the acceptor and printer 10 includes a housing 12 receiving therein a validator 14 for both currency and coupon validation. The instant invention contemplates that a single validator 14 may be employed for “reading” bills and coupons that are tendered by users, as well as coupons that are printed by the assembly 10 for dispensing. This latter reading is for purposes of verifying the coupon has been accurately printed. In order to achieve the requisite coupon and currency validation, the validator 14 is provided with appropriate sensors, which may include magnetic heads, bar code readers, character recognition readers, color sensors, pattern recognition sensors, and the like.

A coupon tray dispenser 16 is maintained within the housing 12 and, in one preferred embodiment, is positioned beneath the validator 14. The coupon tray dispenser may have a thermal printer 24 at one end thereof for purposes of printing upon the coupon blanks received within the tray dispenser 16. It is contemplated that the coupons may be maintained within the tray 16 in a fan fold manner, although the invention also contemplates single separated coupons as well.

A stacker 18, preferably of the cassette type, is maintained within the housing 12 beneath the validator 14 and coupon dispenser 16, as shown. A handle 20 allows for ease of removal and replacement of the stacker 18, while a latch 22 serves to secure the stacker within the housing 12. Those skilled in the art will readily appreciate that a suitable stacker would typically include a “punch” and spring-loaded platen to secure the currency and coupons received within the stack.

As discussed above, an appropriate printer, such as a thermal printer 24, is maintained within the housing 12 and, in a preferred embodiment, is positioned at an end of the tray 16 and provides means for printing coupons from coupon blanks maintained within the tray 16. In its preferred embodiment, the thermal printer 24 may print either bar code indicia and/or alpha-numeric characters. The printer 24 may be either integral with the tray 16, or secured to the housing 12. In the latter event, it is most desirable that the printer 24 be readily accessible for cleaning.

A slot 26 is maintained at a top area of the validator 14 and communicates with a transport path 28 to receive and transport currency and coupons into and out of the acceptor 14. As shown, drive wheels 30 are provided in association with a first horizontal portion of the path 28 to receive and transport currency and coupons through a validation area of the validator 14. As will be appreciated by those skilled in the art, various sensors, heads, and “readers” are positioned therealong for purposes of authenticating the tendered bill or coupon. As will further be appreciated by those skilled in the art, the drive wheels 30 are reversible, adapted to reject a coupon or currency tendered as valid, but which fails the tests undertaken along the path 28. If determined to be valid, the currency and coupon is transported along the horizontal and then vertical portions of the path 28 and into the stacker 18. If determined to be invalid, the wheels or rollers 30 are reversed and the note or currency is returned out of the slot 26.

A drive wheel 32 is provided in association with the tray 16 to feed individual coupons or a web of coupons from the tray 16 and into the transport path 28. Such action is taken when a coupon is to be printed and dispensed. As shown, the print head 24 is in juxtaposition to the drive wheel 32 such that the coupon can be printed at the printer 24 and introduced into the note path 28 by the wheel 32.

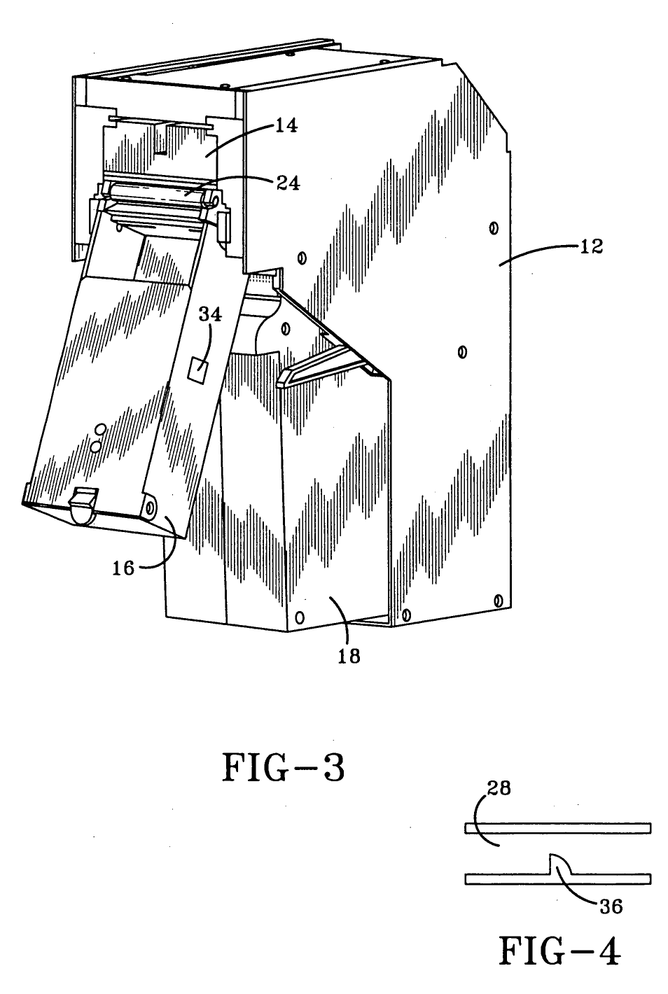

As best shown in FIG. 3, the tray 16 may include a processor chip or “smart” chip 34 in association therewith. The “smart” chip 34 may be provided to receive data respecting the printing and dispensing of coupons from the tray 16 and print head 24. Accordingly, when the tray 16 is removed and replaced with a subsequent tray of blank coupons, the data maintained within the chip 34 may be downloaded or read for purposes of accounting and the like.

With reference now to FIG. 4, it can be seen that the transport path 28 is provided with a means for allowing for ease of separation of individual coupons from the fan-folded web of coupons maintained within the tray 16. For this purpose, a protrusion or button 36 is provided along the bottom of the path 28 and traversing the path at a point such that the leading edge of the coupon and the horizontal portion of the path 28 has not yet been exposed at the slot 26. The drive wheels 30, 32 are controlled such that the web of coupons is stopped with the perforations of the leading coupon being positioned over the protrusion or button 36, providing stress at these perforations. At this point, the wheels 30 are driven in a direction to expel the coupon from the slot 26, while the roller or wheel 32 is reversed to retract the web of fan-folded coupons. In the preferred embodiment, the length of each coupon is such that the wheel 32 is in engagement with the next subsequent coupon such that only a single line of perforations is between the oppositely driven wheels 30, 32. The reversing of the wheels causes the perforations to separate, allowing for release of the leading printed coupon and its distribution to the user through the slot 26. The roller 32 then retracts the subsequent coupon back into the tray 16 and out of the note path 28.

With an understanding of the structure of the invention, further consideration regarding its operation will now be given. As presented above, the single transport path 28 is adapted to receive and accommodate both currency and coupons. For that purpose, when a coupon is to be printed and dispensed, the system inhibits the receipt at the slot 26 of any tendered coupons or bills. Similarly, if a coupon or bill is entered, the system inhibits the operation of the print and dispensing mechanism. As a consequence, the printing and dispensing operations operate mutually exclusively of the receiving and validating operations.

The invention also contemplates the verification of a coupon after it is printed to ensure that no improperly printed coupons are dispensed. For this purpose, a “read after print” process is employed. After the printer 24 prints a coupon in accordance with data received from the gaming machine, the drive wheel 32 causes the coupon to continue its transport along the path 28 where the validation sensors “read” the coupon to determine that the coupon contains the value intended. In other words, the value printed on the coupon, either by bar code or alpha-numeric characters, is verified against the intended value received from the associated gaming machine. If the values do not match, the coupon is not dispensed, but the drive wheels 30 are reversed and the coupon is placed into the stacker 18. The same sensors and transport path employed for receiving and validating coupons tendered by a user are also used to validate a coupon printed by the printer 24. It is further contemplated that the improperly printed coupon may be obliterated or otherwise “spoiled” before it is deposited in the stacker 18. For that purpose, it is contemplated that the coupon may be reversed across the printing head 24 where obliterations are printed thereon and subsequently the obliterated coupon is retracted and passed along the path 28 into the stacker 18.

As presented above, the invention further contemplates the cassette nature of both the stacker 18 and the tray 16, such that a full stacker 18 may be removed and replaced with an empty one, and an empty tray 16 may be removed and replaced with a full one. It is contemplated that the tray 16 operate as a drawer, sliding upon rails or appropriate ways. The stacker 18 may be of conventional nature, also having a “smart” chip, and being maintained upon tracks, rails or ways.

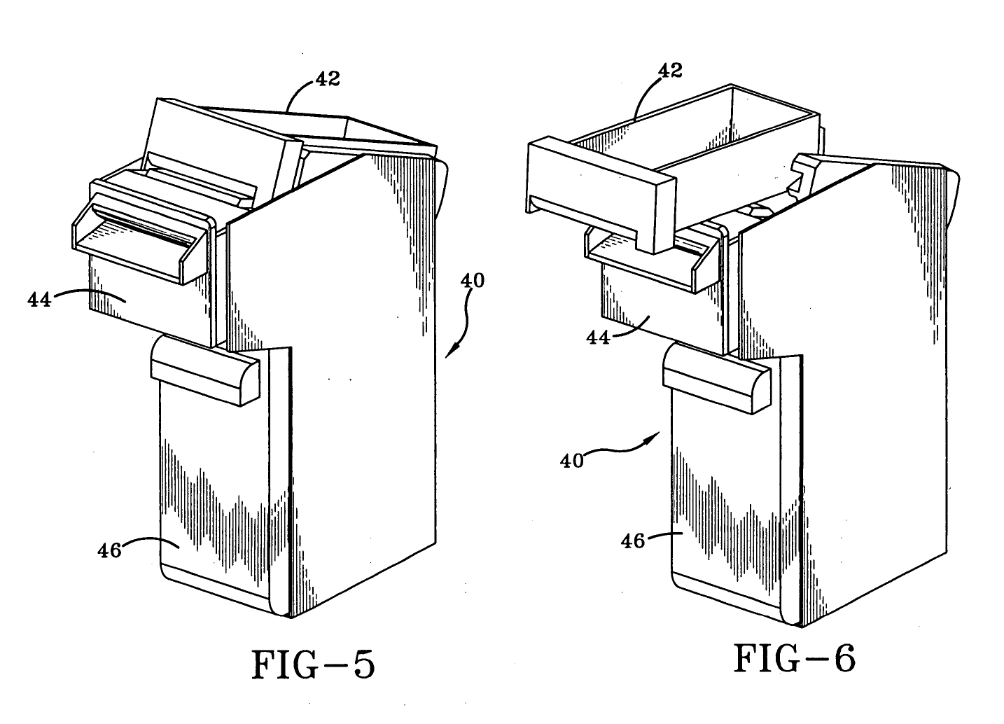

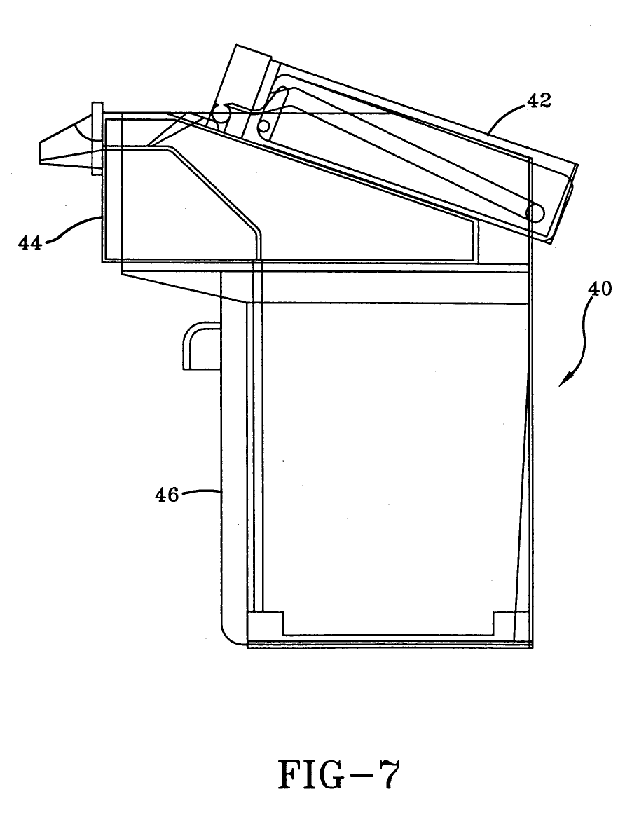

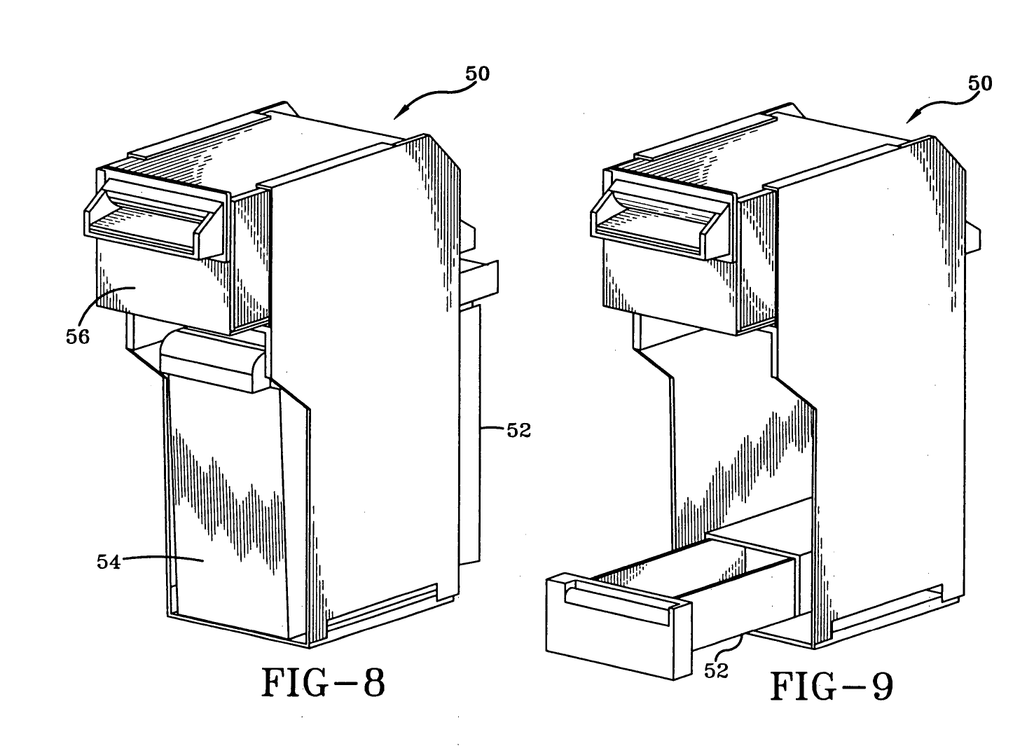

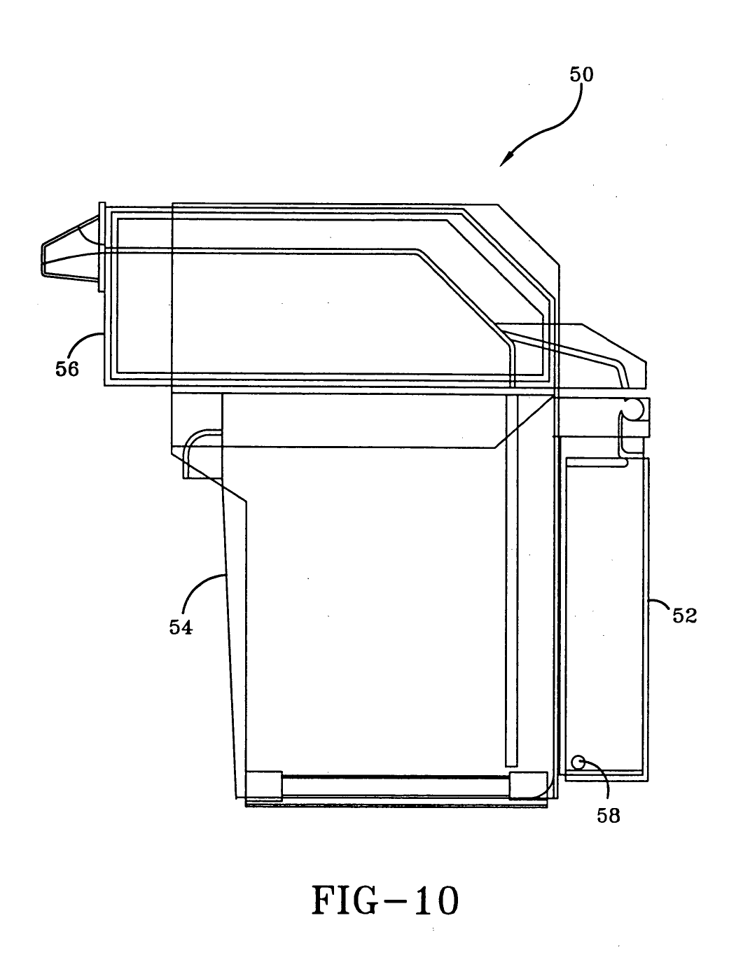

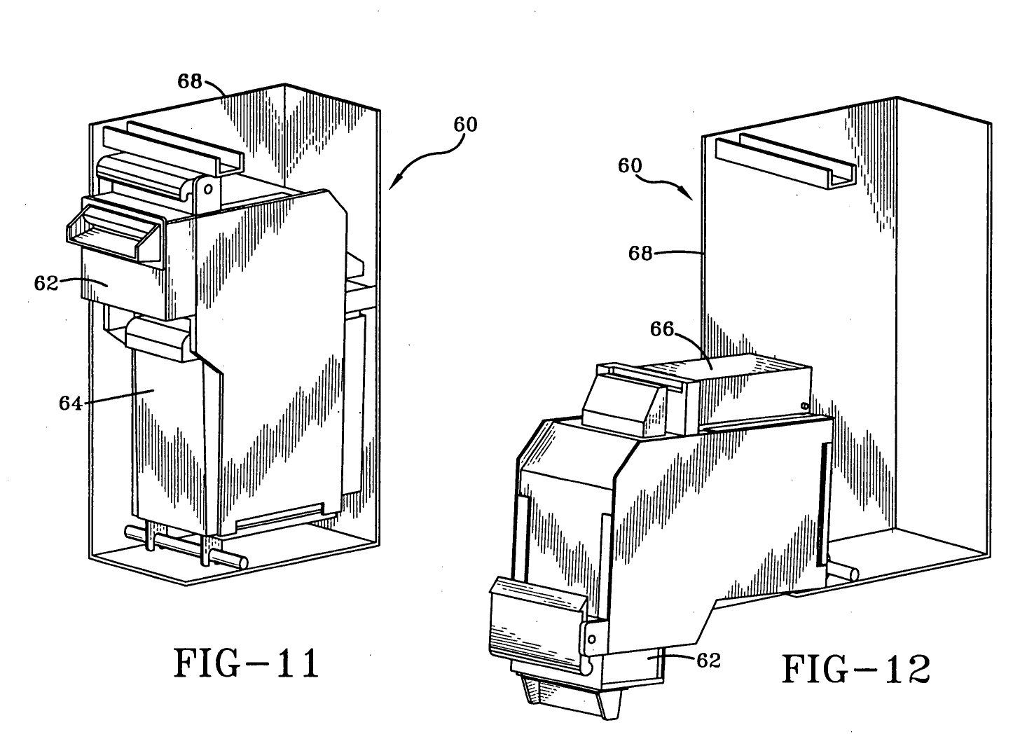

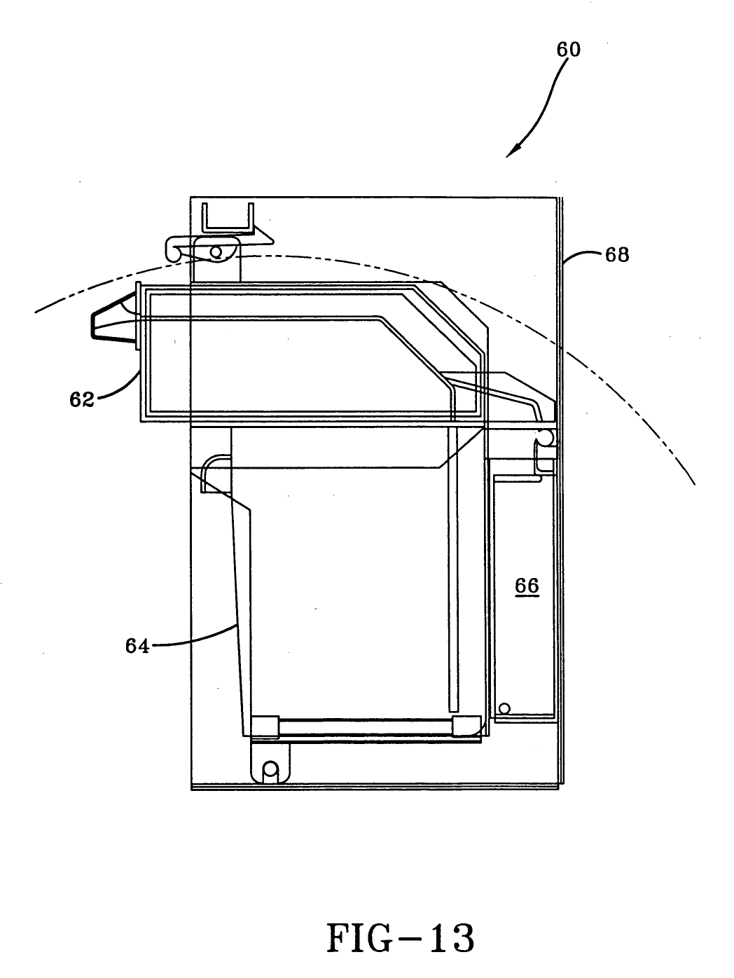

FIGS. 1-4 present one preferred embodiment of the invention. However the invention also is contemplated in various other forms, while still satisfying the general objects of the invention. In this regard, reference should be made to FIGS. 5-7, wherein an acceptor and printer 40 is presented showing the coupon printer 42 maintained above the acceptor 44 and stacker 46 portions of the structure. Similarly, FIGS. 8-10 show an acceptor and printer 50 in which the coupon tray and printer 52 is maintained behind the stacker 54, which is beneath the acceptor 56. The printer tray 52 is pivotally mounted to the assembly housing as at 58 for ultimate drawer-like extraction when the stacker 54 is removed. Similarly, FIGS. 11-13 present yet another acceptor and printer 60 according to the invention, wherein the entire acceptor 62, stacker 64 and printer assembly 66 is maintained on a rotatable chassis within an appropriate housing 68.

Thus it can be seen that the objects of the invention have been satisfied by the structure presented above. The true scope of the invention, however, will be provided by way of patent claims, should a utility patent ultimately be filed.

What is claimed is:

1. A currency and coupon acceptor, comprising:
a housing;
a validator received within said housing for determining the authenticity and associated value of paper items tendered thereto;
a stacker received within said housing for receiving and maintaining tendered paper items determined to be authentic;
a printer in association with said tray of blank coupons for printing data upon coupons dispensed from said tray; and
a note path interconnecting said validator, tray of blank coupons, stacker and printer for transporting said paper items.

2. The currency and coupon acceptor according to claim 1, wherein said paper items to be authenticated by said validator comprise paper currency and coupons.

3. The currency and coupon acceptor according to claim 2, wherein said note path has associated drive wheels, said drive wheels being reversible for selectively receiving and returning paper items tendered for authentication.

4. The currency and coupon acceptor according to claim 3, wherein said note path extends between a slot, where a paper item is tendered, and said stacker, where said paper item is received and maintained upon validation.

5. The currency and coupon acceptor according to claim 4, wherein blank coupons are dispensed from said tray into said note path, and transported by said drive wheels past said printer, where data is printed thereon, and then past said validator, where said data is verified.

6. The currency and coupon acceptor according to claim 5, wherein said printed coupon is transported out of said slot upon verification of the accuracy of the data printed thereon, and to said stacker upon failure of said verification.

7. The currency and coupon acceptor according to claim 6, wherein a printed coupon, having failed verification by said validator, is voided by said printer as it is transported to said stacker.

8. The currency and coupon acceptor according to claim 6, wherein said coupons are maintained in said tray as a continuous web of fan folded coupons separably interconnected by transverse perforated lines, and wherein a protrusion extends from said note path between said tray and said slot, a coupon being separated from said web by rotation of certain of said drive wheels in opposite directions when a said perforated line is positioned at said protrusion.

9. The currency and coupon acceptor according to claim 1, wherein a data accumulating chip is associated with said tray and said printer, said chip receiving and storing data corresponding to data printed on said coupons dispensed from said tray.

10. The currency and coupon acceptor according to claim 9, wherein said tray is removable from said housing, and said data accumulating chip is mounted upon said tray.

11. The currency and coupon acceptor according to claim 1, wherein said stacker comprises a cassette, removably and interchangeably received within said housing.

12. The currency and coupon acceptor according to claim 1, wherein said coupons have coded data thereon, said validator being configured to sense said coded data, and said printer being configured to print said coded data.

13. The currency and coupon acceptor according to claim 1, wherein said coupons have alpha-numeric data thereon, said validator being configured to sense said alpha-numeric data, and said printer being configured to print said alpha-numeric data.

14. The currency and coupon acceptor according to claim 1, wherein said tray of blank coupons is positioned beneath said validator.

15. The currency and coupon acceptor according to claim 1, wherein said tray of blank coupons is positioned atop said validator.

16. The currency and coupon acceptor according to claim 1, wherein said tray of blank coupons is positioned behind said stacker, said tray being pivotally connected to said housing.

17. The currency and coupon acceptor according to claim 1, wherein said printer is mounted to said tray.
